(19) United States
(12) Patent Application Publication
(10) Pub. No.: US 2022/0198550 A1
(43) Pub. Date: Jun. 23, 2022

(54) SYSTEM AND METHODS FOR CUSTOMER ACTION VERIFICATION IN A SHOPPING CART AND POINT OF SALES

(71) Applicant: Tracxone Ltd, Nesher (IL)

(72) Inventors: Moshe MEIDAR, CoralGables, FL (US); Gidon MOSHKOVITZ, Haifa (IL); Itai WINKLER, Haifa (IL)

(73) Assignee: Tracxone Ltd, Nesher (IL)

(21) Appl. No.: 17/604,838

(22) PCT Filed: Apr. 29, 2020
(86) PCT No.: PCT/IL2020/050480

§ 371 Date: Oct. 19, 2021

Related U.S. Application Data
(60) Provisional application No. 62/840,592, filed on Apr. 30, 2019.

(51) Int. Cl. G06Q 30/06; G06Q 20/20; G06Q 20/18; G06V 10/22

(52) U.S. Cl. CPC G06Q 30/0637; G06V 10/225; G06Q 20/18; G06Q 20/208

(57) ABSTRACT

The disclosure is directed to system, methods and programs for automatic verification and validation of users' actions during assembly of products intended for purchase in a shopping cart, more specifically, the disclosure is directed to systems, methods and programs for automatically validating correct identification and markings of items inserted to an artificially intelligent shopping cart by using action-recognition associated with correct scanning/presentation of the item to a product recognition module coupled to the artificially intelligent shopping cart.

### BACKGROUND

The disclosure relates to system, methods and programs for automatic verification and validation of users' actions during assembly of products intended for purchase in a shopping cart. More specifically, the disclosure relates to systems, methods and programs for automatically validating correct identification and marking of items inserted to an artificially intelligent shopping cart by using action-recognition associated with correct scanning/presentation of the item to a product recognition module coupled to the artificially intelligent shopping cart.

The goals of a self-checkout system are to increase shopper throughput and to save in labor costs. Ideally, a shopper can scan his/her items when selected from the shelf and save scanning time at the checkout line. In addition, stores would require less human labor since there is a reduction in the number of cashiers required. It is well recognized that a system where every shopper has all of his purchase items re-scanned is not feasible since there is no net time savings in such a system (all purchases are scanned by a cashier anyway).

There is therefore a need to determine whether a shopper needs to be audited and how many and which items are to be scanned in order to maximize the potential for catching pilferage, provide maximum deterrence against theft, minimize labor costs in checking the shoppers' scanned items, maintain the increased throughput achieved by the self-checkout system, and avoid the negative inferences inherently made by shoppers whose items are checked by an exit cashier or security guard. Conversely, the system must be specific enough to ensure there are no billing errors that cause over billing of the shopper, due to misidentification of the scanned items, double scanning or the like.

However, in such self-service shopping carts (see e.g. U.S. Pat. No. 6,484,939), there is no verification and validation for the user's actions, such as which products were actually inserted into the cart's basket nor are these shopping carts allow for removal of items from the shopping cart. This can eventually lead to misuse and fraudulent behavior by the users (type II error), or alternatively, to over-billing of the user (type I error).

The systems, methods and programs provided herein address the shortcomings of the current technology.

### SUMMARY

Disclosed, in various implementations, configurations and embodiments, are system, methods and programs for automatic verification and validation of users' actions during assembly of products or items intended for purchase in a computerized, artificially intelligent shopping cart and point of sales.

In an exemplary implementation, provided herein is a system for automatic verification of insertion and/or removal of an item from an artificially intelligent shopping cart (AIC), the system comprising: the shopping cart having a front wall, a rear wall and two side walls forming an apically open container with a base; a product recognition module; a user interface (UI) module; optionally, a load cell module operably coupled to the base of the shopping cart; a plurality of imaging modules coupled to the cart, adapted to capture at least one of: image of an item inserted into the cart, image of an item removed from the shopping cart, and image of an area of interest outside the cart, and an image of the operating area of a shopping cart; an indoor positioning sensor; and a central processing module in communication with the: user interface module; optionally the load cell, and (not optionally), the plurality of imaging modules, the central processing module comprising at least one processor and being in further communication with a non-volatile memory device storing thereon: an action recognition module; an items' characteristics database; an items' features database; items' classifiers' database; a data fusion and decision module; a verification and notification module; and a processor readable media comprising a set of executable instruction, configured, when executed to cause the at least one processor to: identify an action by a user associated with at least one of: a product insertion, and a product removal from the cart; determine if the at least one of: insertion, and removal of the item is recorded by the product recognition module; and if the item is recorded by the product recognition module, and using the verification and notification module, mark the item insertion or removal as verified; else using the verification and notification module, notify at least one of the user, the store, and the warehouse of an unverified insertion and/or removal of the item.

In another exemplary implementation, provided herein is a computerized method of verifying product insertion in a shopping cart, a basket, or an automatic cashier station of at least one of: a store, and a warehouse, implemented in a system for automated product verification, the system comprising: the shopping cart, basket, or automatic cashier station, the shopping cart or basket having a front wall, a rear wall and two side walls forming an apically open container with a base; a product recognition module; a user interface module; optionally—a load cell module operably coupled to the base of the cart; a (non-optional) plurality of imaging modules coupled to the cart, adapted to capture at least one of: an image of an item inserted into the cart, image of an area of interest outside the cart, and an image of the operating area of the cart; an indoor positioning sensor; a central processing module in communication with the: user interface module; optionally, the load cell, and (not optionally) the plurality of imaging modules, the central processing module comprising at least one processor and being in further communication with a non-volatile memory device storing thereon: an action recognition module; an items' characteristics database; an items' features database; items' classifiers' database; a data fusion and decision module; a verification and notification module; and a processor readable media comprising a set of executable instruction, configured, when executed to cause the at least one processor to: recognize an action by a user associated with at least one of: a product insertion, and a product removal from the cart; the method comprising: using the at least one of the imaging modules, identifying an action by the user associated with at least one of: insertion, and removal of an item into or out of the shopping cart, basket or a designated area of the automated cashier's station; determining if the at least one of insertion and removal of the item is recorded by the product recognition module; and if the insertion or removal of the item is recorded by the product recognition module, and using the verification and notification module, mark the item insertion or removal as verified; else, using the verification and notification module, notify at least one of: the user, the store, and the warehouse of an unverified insertion and/or removal of the item.

These and other features of the system, methods and programs for automatic verification and validation of users' actions during assembly of products intended for purchase in a shopping cart, will become apparent from the following detailed description when read in conjunction with the figures and examples, which are exemplary, not limiting.

### BRIEF DESCRIPTION OF THE FIGURES

For a better understanding of the system, methods and programs for automatic verification and validation of users' actions during assembly of products intended for purchase in a shopping cart, with regard to the exemplary implementations thereof, reference is made to the accompanying examples and figures, in which:

FIG. 1, illustrates an exemplary implementation of the AIC components' architecture;

FIG. 2, illustrates an exemplary implementation of the AIC's verification system components;

FIG. 3A, is a flow chart of the method for validation/verification of product insertion into the AIC with a load cell, with similar process without a load cell illustrated in FIG. 3B;

FIG. 4A, is a flow chart of the method for validation/verification of product removal from the AIC with a load cell, with similar process without a load cell illustrated in FIG. 4B; and

FIG. 5, is an exemplary implementation of the application of a partial skeleton model for action recognition used in validation/verification of user action associated with proper item scanning.

### DETAILED DESCRIPTION

Provided herein are exemplary implementations of systems, methods and programs for automatic verification and validation of users' actions during assembly of products intended for purchase in a shopping cart.

The verification/validation methods, programs and systems described herein are used to verify that an item(s) placed in the AIC was scanned correctly, ensuring that the store/warehouse will not experience financial loss of revenue from customer misuse or fraudulent behavior (grazing). Such verification/validation will reduce the operating loss due to the use of self-checkout carts and/or point of sales. Additionally, automatically verifying and/or validating the customer actions during shopping, such as verifying that the inserted products are marked correctly, can help deter fraudulent behavior.

The system is configured to analyze and fuse data from different sources and sensor types, positively establishing whether an insertion or removal of a product/item took place, and to verify that the scanned product/item matches in appearance, weight and other characteristics, to the product that was placed in the shopping basket.

The different sensors used can be, for example; multiple optical, digital cameras such as RBG cameras, Infrared cameras, depth cameras, video cameras, and a specialized load cell system. The imaging module, referring to all camera arrays and other imaging sensors, is configured to provide visual information from the AIC's interior basket, the cart's operating region and the cart's periphery. Each set of imaging modules (internal, operating and peripheral e.g.,), undergoes a specialized computer vision algorithm to obtain certain discrete information related to the customer behavior and action during shopping such as product selection, product scanning and other shopping-related information used to verify the integrity of the self-check out process. Although the AIC verification system described here is able to verify the shopping actions carried out by a user, it is not generally intended to provide product recognition ability.

Self-service cash register (SSCR) systems present different challenges that can be addressed by the imaging module and the various sensors, and the central processing module, coupled to, instead of the AIC, to the self-service cash register station (see e.g., U.S. Pat. No. 9,747,759). In using the SSCR, customers typically pass individual articles selected over/under/in front of (a) scanner(s), via which the bar code of the articles is scanned. Thereafter, the scanned articles are typically bagged by the customers and weighed using a stationary load cell. Thereby, weight of a newly added article is determined against a weight data base matching with the article scanned by means of the scanner (thus verified). If the customer wishes to cancel an already scanned article, they typically have to manually input this action via available UI, which is often a complex series of operation or require the assistant of a store employee. Problems may also occur when the customer does not stick to the sequence of steps provided for the operation of the SSCR system in that the user, for example, again removes already scanned articles from the bags, or, in another example, when a customer replaces a verified article with a different, unverified article (of a higher price). Using the insertion/removal verification methods implemented using the imaging module in combination with the methods provided, visual verification of insertion and/or removal can be implemented without the use of the load cell and is contemplated as within the scope of the disclosure.

It is contemplated that to get an accurate billing, or marking/registering of the items/products in the check-out process of the AIC and/or SSCR, certain actions by the user must be ascertained properly. That is, every product inserted to the AIC and/or SSCR is properly recorded; as is every product/item removed. Under these circumstances, a true insertion (TI) is a product/item insertion that is properly identified and recorded while a true removal (TR) is the removal of a product/item that is properly identified and recorded. Conversely, false insertion (FI, type I error) can be regarded an insertion that was incorrectly identified and incorrectly recorded, while a false removal (FR, type II error) can be regarded as product/items which removal was incorrectly identified and incorrectly recorded.

In an exemplary implementation, the sensitivity of the systems, methods and programs provided herein can be regarded as:

$$sensitivity = \frac{TI}{TI + FR}$$

While the selectivity of the systems, methods and programs provided herein can be regarded as:

$$selectivity = \frac{TR}{TR + FI}$$

There are multiple scenarios which can lead to loss of goods and/or income of a store or a warehouse, or over billing of the customer, none of which is desired. These can be, for example:
A product (interchangeable with article) placed in the collection-basket (interchangeable with AIC, trolley, cart, or hand-basket) or bagged without being scanned (FI).
A product bagged or placed in the collection-basket with a different product, typically cheaper, being scanned instead (FI).
A product being scanned/selected (in other words, not by active scanning using a bar-code/QR scanner) once when plurality of products of the same type are bagged or placed in the collection-basket without being scanned (FI)
A product scanned/selected for removal while being kept in the cart's basket or bag
A product scanned for removal with a different product actually removed from the shopping cart or bag (FR).
A user deliberately damaging the cart or the cart's hardware.
A user removing the cart from the store/warehouse premises
   All of these scenarios can be a result of a ‘naive’ customer misuse or by intentional fraudulent behavior.

In an exemplary implementation, the systems, methods and programs provided herein are configured to increase both the sensitivity and selectivity of the check-out process using the AIC. Accordingly, provided herein is a system for automatic verification of insertion and/or removal of an item from an artificially intelligent shopping cart (AIC), the system comprising: the shopping cart having a front wall, a rear wall and two side walls forming an apically open container with a base; a product recognition module; a user interface module; a load cell module operably coupled to the base of the shopping cart; a plurality of imaging modules coupled to the cart, adapted to capture at least one of: image of an item inserted into the cart, image of an item removed from the shopping cart, and image of an area of interest outside the cart; an indoor positioning sensor; and a central processing module in communication with the: user interface module; the load cell and the plurality of imaging modules, the central processing module comprising at least one processor and being in further communication with a non-volatile memory storing: an action recognition module; an items' characteristics database; an items' features database; items' classifiers' database; a data fusion and decision module; a verification and notification module; and a processor readable media comprising a set of executable instruction, configured, when executed to cause the at least one processor to: identifying an action by a user associated with at least one of a product insertion, and a product removal from the cart; determine if the at least one of insertion and removal of the item is recorded by the product recognition module; and if the item is recorded by the product recognition module, and using the verification and notification module, mark the item insertion or removal as verified; else using the verification and notification module, notify at least one of the user, the store, and the warehouse of an unverified insertion and/or removal of the item.

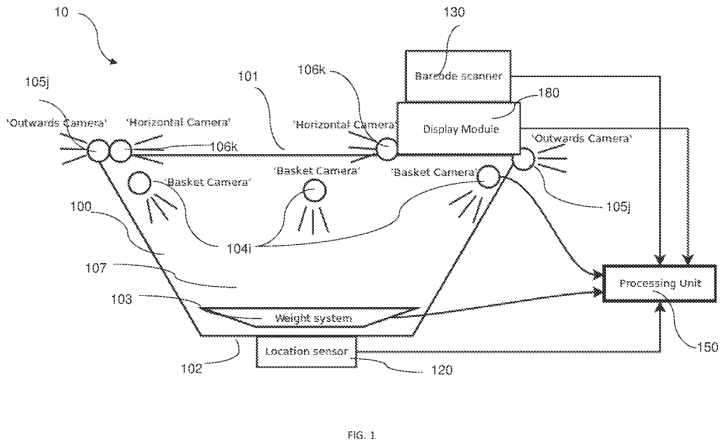

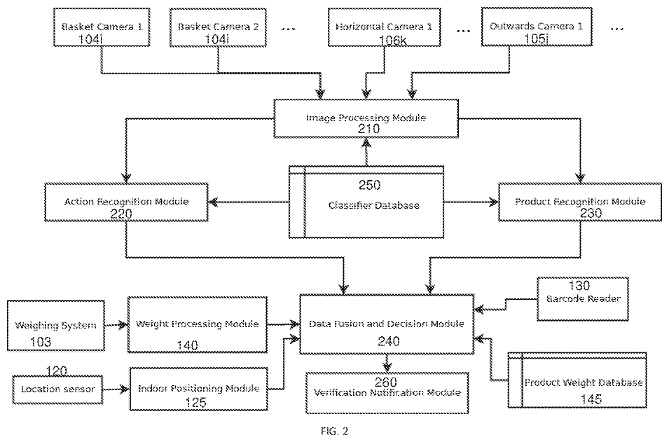

In order to accomplish such verification (or increase in verification sensitivity and selectivity), as illustrated in FIG. 1, the system processes data from at least one of the imaging module sets 104i, 105j, and 106k, located on AIC 10 (or alternatively, on SSCR station (not shown)) and in another configuration, this also includes an optional specialized load cell module 103 located beneath the shopping cart's basket. The imaging module sets' 104i, 105j, and 106k, array can each comprise at least one optical camera, such as RGB cameras, Infrared (IR) cameras and depth cameras (RGBD cameras). Imaging module sets 104i, 105j, and 106k are operable to provide visual information on inserted/removed products and information on the shopper's (interchangeable with customer, user) actions. The optional weighing system is a specialized load-cell-based module 103 that is operable to provide weight measurements under challenging cart dynamics that typically include various types of accelerations/decelerations. For SSCR systems, the optional load cell can be comprised, for example, of a load plate supported on a bridge-like two load cells operable to provide an electric signal corresponding to the weight of the article placed on the load plate. Another example, can be a load plate (whether transparent or not), disposed on a piezoelectric load cell, and the like.

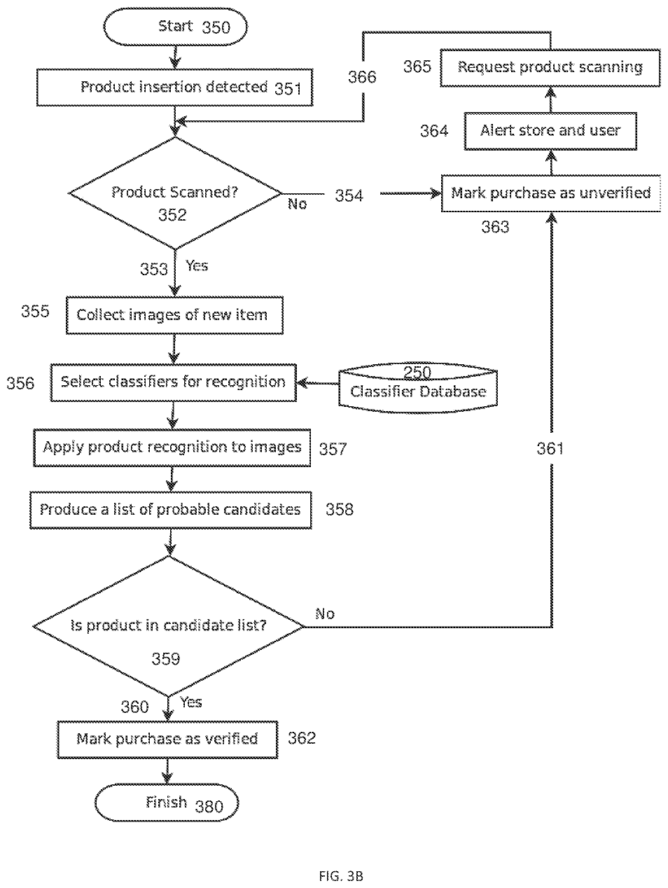

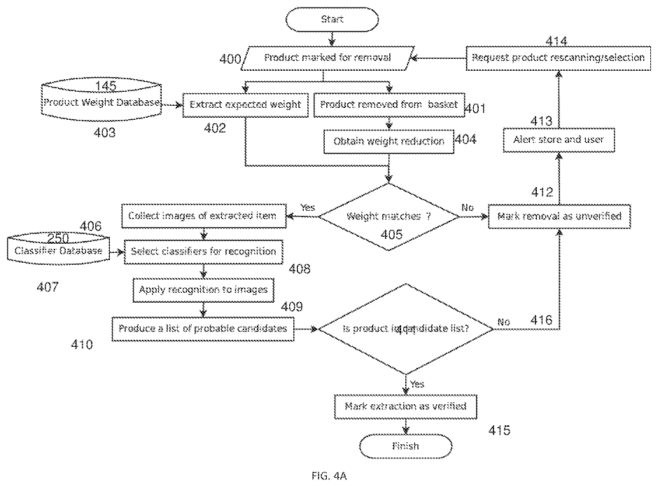

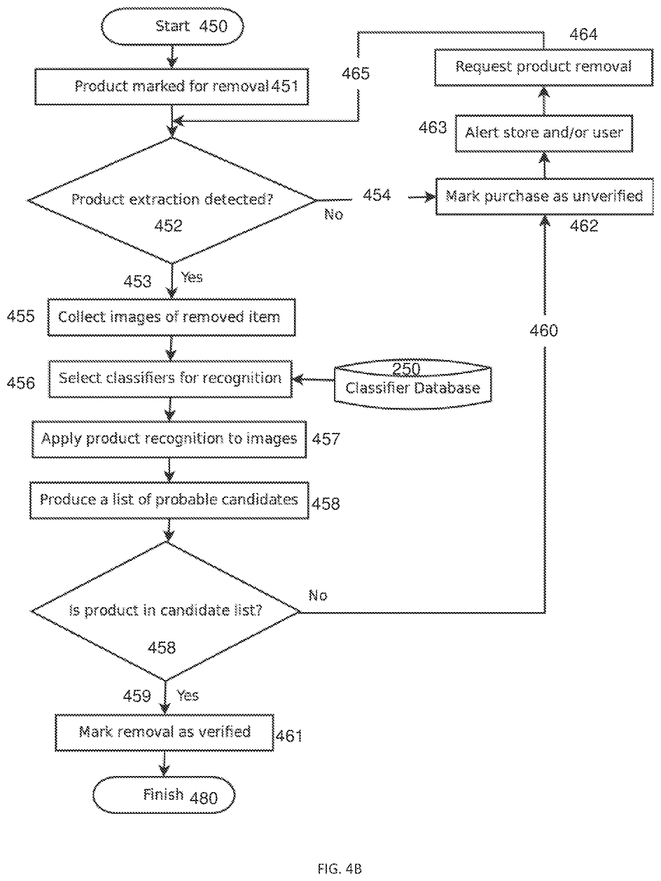

All sensor input signals', including imaging module, are processed in a central processing unit (CPU, see e.g., FIG. 1, element 150). CPU unit 150 can be comprised of a single or multiple processors such as CPU and/or GPU. Further, processing unit 150 is configured to collect and execute the processing methods of system 10 (or SSCR systems). In addition all sensors (interchangeable with signal source(s), or ‘sources’) within the cart, including imaging module sets 104i, 105j, and 106k, optional weighing system 103, barcode scanner 130 and other (e.g., location sensor 120) are synchronized by CPU 150 so that events from different sources can be matched in time (See e.g., steps 301, 302, 351, 352 and 401, 402, 451, 452 in FIGS. 3A, 3B, 4A and 4B respectively).

It is noted that the term “imaging module” as used herein means a unit that includes a plurality of built-in image and/or optic sensors and outputs electrical signals (that become input signals to the verification process), which have been obtained through photoelectric conversion, as an image, while the term “module” refers throughout the disclosure to software, hardware, for example, a processor, or a combination thereof that is programmed with instructions for carrying an algorithm or method. The modules described herein may communicate through a wired connection, for example, a hard-wired connections, a local area network, or the modules may communicate wirelessly. The imaging module may, for example, comprise charge coupled devices (CCDs), a complimentary metal-oxide semiconductor (CMOS), an RGB-D camera, or a combination comprising one or more of the foregoing. If static images are required, the imaging module can comprise a digital frame camera, whereas the field of view (FOV) can be predetermined by, for example, the various cameras size, intrinsic characteristics and the distance from a point of interest in the cart/bagging area. The cameras used in the imaging modules of the systems and methods disclosed, can be a digital camera. The term “digital camera” refers in an exemplary implementation to a digital still camera, a digital video recorder that can capture a still image of an object and the like. The digital camera can comprise an image capturing unit or module, a capture controlling module, a processing unit (which can be the same or separate from the central processing module).

The AIC/SSCR can further comprise a user interface (UI) module with a display such as a touch-screen, which allows the user to interact with the AIC through a designated software. Moreover, the systems used herein can be computerized systems that further comprise a central processing module; a display module; and a user interface module. The Display modules, which can include display elements, which may include any type of element which acts as a display. A typical example is a Liquid Crystal Display (LCD). LCD for example, includes a transparent electrode plate arranged on each side of a liquid crystal. There are however, many other forms of displays, for example OLED displays and Bi-stable displays. New display technologies are also being developed constantly. Therefore, the term display should be interpreted widely and should not be associated with a single display technology. Also, the display module may be mounted on a printed circuit board (PCB) of an electronic device, arranged within a protective housing and the display module is protected from damage by a glass or plastic plate arranged over the display element and attached to the housing.

In addition, “user interface (UI) module” broadly refers to any visual, graphical, tactile, audible, sensory, or other means of providing information to and/or receiving information from a user or other entity. For example, a set of instructions which enable presenting a graphical user interface (GUI) on a display module to a user for displaying and changing and or inputting data associated with a data object in data fields. In an exemplary implementation, the user interface module is capable of displaying any data that it reads from the imaging module. In addition, the term ‘module’, as used herein, means, but is not limited to, a software or hardware component, such as a Field Programmable Gate-Array (FPGA) or Application-Specific Integrated Circuit (ASIC), which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The barcode scanner can be laser-based or image-based and as used herein, includes the broader definition incorporating both linear and two dimensional symbologies and is designed to detect and decode information from a light intensity pattern. However, without any means for knowing if the bar code just scanned was on a box, on a book, or on an individual fruit, the bar code scanner used in the systems and methods described herein, can be replaced, or augmented for example by a product imaging module. Such product imaging module can require a shopper (interchangeable with user, customer and the like), to hold the product in the scanner FOV, then the product is visually recognized with or without having the barcode in its field of view.

As illustrated in FIG. 1, AIC 10 (as will the SSCR system) has multiple imaging module sets 104i, 105j, and 106k, positioned to capture various regions in the shopping scene as well as within the AIC. Imaging module sets 104i, 105j, and 106k utilizes various image capturing configurations based on their intended use. In an exemplary implementation, the first set of AIC/SSCR imaging module 104i (for example, RGB-D camera) are configured to capture the interior of the shopping cart, or the immediate bagging area of the SSCR. This imaging module set is configured to capture the products/items following their placement in the shopping-basket 107, or bagging area. Imaging module set 104i, provide visual information on products placed in the cart's basket; as well as information on various interactions between the user and the interior if the cart/bag, such as rearranging the products, placing/bagging objects which are not among the store-goods (e.g. wallet, purse, coat, etc. . . . ).

Since the products placed in basket/bag 107 remain static, imaging module set 104i can be configured to capture images using a low frame rate (for example, between about 1 frames per second (fps) and about 45 fps, or between about 5 fps and about 33 fps, for example, between about 10 fps and about 22 fps), and still provide high-resolution data that can be used for extracting information of a newly inserted product. As illustrated, imaging module set 104i. in the context of the AIC, are termed and referred to by “Basket Camera” throughout this description.

Other imaging module sets (e.g., 105j, 106k) are positioned so that their field of view (FOV) can capture the product/item's image in the process of being inserted (removed) to (from) the shopping-basket (bag) (i.e. during its placement/bagging in the basket/bag 107) and also to capture the shopper's actions while scanning the product prior to its placement/bagging in the basket/bag or the shoppers interaction with the operating region. Imaging module set 106k (e.g., RGB cameras), will typically capture top 101 of the cart's (SSCR point of bagging) 100 basket/bag 107 and can also be adapted to provide visual information on a newly inserted (removed) products when the cart/bag is full. Imaging module set 106k is referred to, in the context of the AIC, as “horizontal-cameras” throughout this description. “Horizontal cameras” 106k can therefore be configured to work in higher frame rate. High frame rate (e.g., >30 fps) is needed in an exemplary implementation to capture a clear image of the product while in motion. In an extreme scenario, the product can be thrown into the basket/bag resulting a fast free-fall motion into the shopping basket/bag 107. The frame-rate and exposure time (e.g., less than 33 ms, depending on intrinsic camera parameters and external lighting in the immediate surrounding) of the various cameras, comprising the imaging module sets, are configured to produce high quality images even under such fast product and/or AIC motion dynamics.

Another use of the horizontal cameras, forming a portion of imaging module set 106k is configured to capture the interactions of a customer with the shopping cart, or SSCRE bagging area. Such interactions include, a customer scanning a product with a bar-code scanner, a customer placing a product into the cart/bag, a customer throwing a product into the cart/bag, a customer taking out a product form the cart/bag, a customer interacting (e.g., rearranging items) in the interior of the shopping cart's basket/bag, a customer causing physical damage to the cart or cart's/SSCR hardware, a customer removing the cart from the store premises (i.e. stealing the cart).

The recognition of the customer actions is one of the steps used for verification of customer's actions, such as to verify that products registered for purchase by the customer match the products physically located in the bag/AIC basket. For example, if the customer is requested to scan the product by a barcode-scanner prior to its insertion into the basket/bag, the system can identify if such action took place using an automated video-processing algorithm such as a gesture/action-recognition algorithm operable to identify an action of barcode scanning/selection and/or product placement. Accordingly and in an exemplary implementation, identifying an action by the user (or shopper, customer and the like) in the systems for validating and verifying correct product insertion and removal from the AIC/SSCR, which is associated with insertion, and/or removal of an item into or out of the shopping cart comprises: using at least one imaging module (for example horizontal cameras forming a portion of imaging module set 106k) and an action-recognition algorithm, identifying at least one action of barcode scanning, and/or presentation of the item to a visual product recognition module, and/or a product insertion, and or a product extraction, obtained from a plurality of image frames of the user over a predetermined period, wherein the action recognition is carried out using an action recognition algorithm, such as a recurrent neural network (RNN)

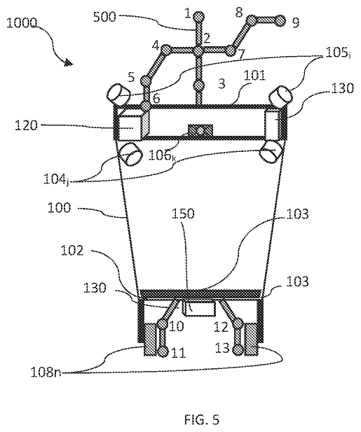

Current state-of-the-art techniques for gesture and action recognition incorporate Deep-Neural-Networks (DNN) with specialized architectures, such as Recurrent-Neural-Networks (RNN), the ‘Two Stream’ Networks, 3D networks, TSN (Temporal Segment Network), T3D (Temporal 3D Networks). For the purposes of this disclosure, the terms “gesture recognition”, and “action recognition” refer to a method for identifying specific movements and/or maneuvers or specifically associated pose configurations performed by a user. For example, gesture/action recognition can refer to identifying a swipe of a hand in a particular direction having a particular speed, or the wave of a hand in the direction of bar code scanner 130. In certain other implementations common methods for gesture/action recognition can be, for example, model-based methods such as a Skeleton model, identifying anatomical features, such as the joints (see e.g., FIG. 5), e.g., of the user's hands and elbow, and then, subsequently, analyzing this tracked data to identify gestures/actions performed by the user

Various additional types and versions of DNN's were suggested for action recognition. Such methods use, for example, a combination of convolutional-neural-network (CNN) with other CNN's/RNN's. One CNN is used to extract features related to a specific frame or concatenated frames and these features are then used as an input to another DNN/CNN identifying an action. Another combination of DNN's are by incorporating information related to the motion fields, such as provided by Optical flow algorithms, with other DNN's, such as in the Two Stream Network. RNN are commonly used for time-series analysis as in a video sequence. Various RNN's such as LSTM (Long-Short-Term-Memory) have been proposed for analysis of time-series data such as in video analysis including for action recognition. An RNN can be used on a sequence of frames or in combination with other feature extractors such as a produced by a CNN. Other common methods in action recognition are based on skeleton models (a.k.a topological skeletons, see e.g., FIG. 5). Such skeleton models a person as a compact 2D/3D graph-based representation where joints 1-13 are represented as the graph nodes. The skeleton model can be used in the methods and systems provided for action recognition with both RNN, as well as with legacy machine learning algorithms. For example, the RNN (such as LSTM network) is used in the methods and programs, and is implemented in the AIC system, or SSCR system provided, is preceded by using convolutional neural networks (CNN), extracting a plurality of action-recognition features from each of the plurality of frames; a motion field between two images, sparse or dense; and inputting the convoluted action recognition features and the motion field features (in other words, creating a “deep feature”) to the RNN. In a specific type of an RNN used in the methods, systems and programs provided herein for accurate action recognition is the LSTM (long-short-term-memory neural network, an advanced RNN architecture which can learn long-range dependencies). Such LSTM can be trained to identify specific actions in video, captured for example using horizontal cameras forming a portion of imaging module set 106k.

Then, applying the skeleton model for example, in the SSCR when the shopper is viewed from the upper side, the approximate pose is estimated, and by comparing with the moving object area in the actually obtained video, the moving object can be clearly defined. It may be defined.

The training data for an action recognition algorithms, such as based on CNN's/RNN's/and other machine learning techniques such as SVM (Support Vector Machine), can be composed of a series of captured images (i.e. video sequence) where the specific customer action is visible. The network is than trained on multiple such annotated images and videos (in other words, supervised learning).

Third types of imaging module set (e.g., 105j) are positioned to capture SSRC/AIC 10 surrounding, therefore, imaging module 105j are termed and referred to as ‘Outwards cameras’ (see e.g., FIG. 1). In outwards-looking views it is possible to visualize the customer actions during the shopping process. Such customer actions can be, for example:
Approaching a store shelf
Picking a product from a shelf
Placing a product on a shelf/bin
Returning a product to the shelf/bin
Approaching the shopping cart/SSCR station with a product
Approaching the shopping cart/SSRC station without a product
Moving the cart in the store.

These customer actions can be automatically (in other words, without user or store's operator's involvement), identified with an action/gesture recognition algorithm such as with an LSTM network, or CNN-LSTM combination as described above.

In some cases ‘Outward Cameras forming a portion of imaging module set 105j can also provide visual information on the product's appearance prior to its capture by the ‘horizontal’ cameras forming a portion of imaging module set 106k and/or ‘Basket cameras forming a portion of imaging module set 104i and be used to complement the capturing of the visual characteristics and/or features of the product/item. In an exemplary implementation, outward-looking cameras forming a portion of imaging module set 105j have wide FOV angle, such as ‘Fisheye’ cameras, so they can capture AIC's 10/SSRC station surrounding over 360° with minimal amount of cameras.

Imaging module data can be combined with supplemental sensor data such as indoor location (120, see e.g., FIG. 1), providing additional information on the probable items that are picked by a customer based on the cart's location within the store/warehouse. Various indoor positioning technologies are available. Examples for such indoor positioning techniques include ‘Bluetooth Low Energy’ (BLE) and Ultra-wide band (UWB), which are short pulses of radio frequency energy. In a location system using UWB technology, the distances and/or bearings are measured by sending UWB pulses, typically on the order of one nanosecond long, between the AIC and the receiving device. The distance between an object and a receiving device can be calculated by measuring the times-of-flight (TOF) of the UWB pulses between the object and the receiving device. UWB signals are assumed to travel at the speed of light, therefore the distance between the object and the receiving device can be calculated from the time taken by a UWB pulse to travel between them.

When an indoor location is provided along with a store Planogram data file, it is used as prior information that can increase the probability and accuracy of the verification of an inserted product. Accordingly and in an exemplary implementation, AIC 10 further comprises a transceiver as location sensor 120 in communication with central processing module 150, transceiver 120 adapted to transmit and receive a signal configured to provide location of AIC 10, for example a UWB signal.

As used herein, the term “planogram” refers to the description of the arrangement of objects in physical location, or a diagram or other representation (e.g., a matrix, a table or chart) of the planned (and thus the expected) placement of products on display shelves. Accordingly, the term “planogram data file” refers to any electronic file that includes a planogram and can be stored in volatile or nonvolatile computer readable memory and, as such, may include data for defining the specifications, quantities, layout, or arrangements of objects in a particular physical location. As used herein, the terms “planogram” and “planogram data file” can also refer to a schematic description that defines a specific arrangement or orientation of objects in a specific physical location and the electronic form of that description, respectively. In one exemplary implementation, the arrangement of the objects may include absolute or relative positions or locations of the objects in a particular physical location. For example, the planogram may include descriptions of different types of frozen vegetables in a freezer bin. The descriptions may include the orientation of the labels for each type of frozen vegetable bags (e.g., facing out), how many wide and tall the bags of each type is stacked, and where in the freezer bin the bag stacks should be located.

The location sensor can be used to detect attempts to remove a cart from the store premises. This can be accomplished by placing additional transmitters in the store's/warehouse's surroundings. If the store surrounding are in an outdoor location, such as an open parking lot, other forms of location technologies can be used interchangeably. One such example is utilizing a GPS based sensor for providing outdoor positioning, or an array of Bluetooth beacons, RFID array and the like, including those embedded in the surface of the parking lot. Same sensor array can also be used for retrieving AIC carts left in the parking lot.

The use of multiple imaging module sets, including different types of cameras in each imaging module set, improves the customer's action verification accuracy during shopping with the AIC. The AIC's imaging module can provide additional supplementary information on the inserted products improving their characterization, thus improving the verification of a product inserted into the cart. An example for such supplementary information can be, for example, the region in the cart where the event (e.g., insertion or removal) was detected, and/or the approximated size and weight of the inserted product. Other type of supplementary information from imaging module originates from infrared cameras forming a portion of one or more of the imaging module sets. Infrared detection helps distinguish cold products such as frozen items from warmer ones and warmer products such as fresh baked products. Another use for infrared can be to differentiate customer's hands from product(s)/item(s), or for tracking a customer within a store. It is further noted, that any gesture/action detection algorithm is not sub-set (e.g., 104i, 105j, and 106k) specific, but rather incorporates data from all image module set 104i, 105j, and 106k as a whole.

Other types of cameras used as components of one or more of the imaging module sets is RGBD (RGB+depth) where the depth measurement provides additional information about the change that occurred in the scene. The use of RGBD improves the accuracy of action recognition algorithms over algorithms that are based on conventional RGB cameras. This is since the depth channel carries additional information regarding the scene which is hard to derive from 2D-RGB images, such as shape and size of an object, a 3D motion field. Other imaging devices that can provide the depth information can be, in other configurations, a stereo-camera arrangement whether static or active. For example, an active stereo camera is used, which use flash or strobe and Time-based computations (time of flight (TOF) e.g.,), to measure the distance between the camera and the object/item/product/article.

A single camera can cover the entire AIC/SSCR basket/bagging area or a fragment of it depending on its position and orientation in the AIC/SSCR station and its field-of-view capabilities. With multiple cameras, an overlapping coverage of the AIC's/SSCR station's basket/bagging area is achieved. This overlapping strategy improves in an exemplary implementation the accuracy of the system and allows to visualize products when the cart is full and/or when some cameras may become obscured by products in the cart's basket, or bagging area.

Other sensor types were also considered for this task but were not selected for the current AIC configuration. Such sensors can be, for example, at least one of: Ultrasound transducers, light detectors, accelerometers, and the like.

The optional load cell module 103 (referring to any device that detects a physical force such as the weight of a load and generates a corresponding proportional electrical signal), is configured to provide weight measurements in a pre-configured sampling rate (a.k.a. weight signal). When a product is added into the cart's basket/load plate in the SSCR bagging area, the weight can further provide valuable verification measure on the weight added to the cart, which is a measure of the inserted product's total-weight. The product weight is than compared to the expected weight of the scanned product.

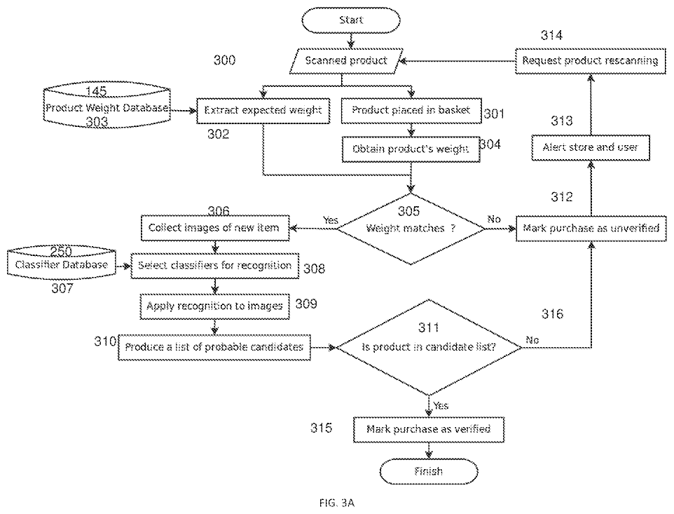

As illustrated in FIG. 2, all sensor's/sources' signal input signals including camera 104i, 105j, and 106k, images, load cell 103 measurements, barcode 130 and location sensor 120 are first synchronized by their sampling time and/or rate. Each input is processed by a designated algorithm to extract the required information needed for the various verification steps. ‘Image Processing Module’ 210 is configured for collecting images and image-sequences (temporally separated frame captures, or, in certain circumstances clips comprising a predetermined number of frames—for example between 2 and 120) from AIC's 10 imaging module sets 104i, 105j, and 106k, and processing them in order to prepare them for ‘Product Recognition Module’ 230 and ‘Action Recognition Module’ 220.

As indicated ‘Basket Cameras forming a portion of imaging module set’ 104i are configured to capture the interior of AIC's 10 basket 107 and are used to visualize the newly inserted products. ‘Image Processing Module’ 210 is configured to crop the raw input images so that any newly inserted product/item is centered within the cropped image. The cropped images are then processed by ‘Product Recognition Module’ 230 to obtain predictions, or assemble a list of probable candidates for the product/item identified within each cropped image. There are several variants for this cropping methods, for example, change detection, optical flow, and another variant uses a CNN for identifying the image region where the new product was introduced into the cart. Both variants can provide some robustness and tolerance to lighting variations and shadows due to the cart motion within the store.

Horizontal cameras forming a portion of imaging module set 106k can be adapted to perform multiple purposes. For example, product capturing during its insertion into the cart's basket. Another example, is capturing the cart's operating area where barcode scanner 130 and display (user interface module) 180 (not shown) are located, thus allowing to visualize the customer interaction with these modules. As indicated, cameras forming a portion of imaging module set 105j are adapted to operate using high frame-rate (e.g., no less than 30 fps), since the motion of a product into or out-of AIC 10 basket 107 may be quick. In an extreme example, a product can be tossed by a customer into the cart. Using a high frame-rate along with adjusted exposure time allows to capture a product during such fast motion with minimal motion blur. The identification of a product/item in an image captured by an horizontal cameras, forming a portion of imaging module set 106k, can be accomplished by identifying regions which exhibit motion. Multiple common techniques can be used for obtaining motion field between two images such as Optical flow and object tracking, other methods can be based on descriptor matching such as oriented FAST (features from accelerated segment test) rotated BRIEF (Binary Robust Independent Elementary Features) descriptor, ORB (Oriented BRIEF), that are used to produce local image description, allowing the detection of the item. Other approaches can utilize deep neural networks for localization of an item in the captured image. Example for such networks include single-shot MultiBox detector (SSD), Regional convolutional neural network (RCNN), Fast-RCNN, Faster-RCNN, you only look once (YOLO), each which were trained to detect and locate desired product/item.

Motion field estimation can help distinguish static regions from moving regions. The direction of the motion field itself is used to infer whether a product and/or a hand were moved into or out of the cart's basket. In addition when it is possible to identify customers hands and crop it from the product in the captured image to obtain improved image intended for product classification. Hand detection can be accomplished by various legacy algorithms such as color-space based algorithms for skin detection. State-of-the-art approaches for hand detection include CNN's trained for that task, an examples for object detection CNN's are YOLO, SSD as described above and various segmentation techniques such as Deeplab and MRCNN (Masked RCNN).

Important customer action that is captured with horizontal cameras forming a portion of imaging module set 106k is the scanning of a product and placing this product in the cart. For verification purposes it is beneficial to verify that a product was scanned, or registered (in the user interface) for purchase, prior to its placement in the basket, and that a scanned product is the same product being placed in the basket. For such purposes the video captured in an example by horizontal camera 106k needs to be processed for action recognition. Recent state-of-the-art algorithms for action recognition can utilize an RNN/LSTM combined with CNN-derived features' and/or based on skeletons combined with an RNN as described herein above. Due to the relatively high frame rate (e.g., to horizontal cameras forming a portion of imaging module set 106k), frames' dilution might be needed to avoid redundant frames. The location of the barcode scanner and/or the location of user operating controls, within the produced frames, can be pre-configured and used as prior information to improve the action recognition accuracy by means of specifying the region of interest in the captured frames.

Likewise, outward-looking cameras forming a portion of imaging module set 105j can be adapted sized and configured (e.g., with wide-angle lens) to capture the scene around AIC 10. Cameras forming a portion of imaging module set 105j can be used, for example, to capture various customer's actions while not interacting with AIC 10. Examples of such actions with importance to action verification include—picking a product from shelf, approaching the AIC with a product, returning a product to a shelf. Additionally outward-looking cameras forming a portion of imaging module set 105j, can be configured to capture images of the product/item while still in the customer's (shopper's) hands.

There are multiple actions of the customer that may need to be detected. However, since the scene (referring to the cumulative image captured by the AIC's imaging module set 105j) is cluttered by other objects such as other customers, other cart's, changing backgrounds, the outwards cameras forming a portion of imaging module set 105j are configured to track their assigned customer within the store. Various approaches for tracking objects in video sequences can be used, for example mean-shift, particle-filter, Kalman-filter, and with a RNN such as those described above. After tracking a customer, the customer's image with the specific action sought to be recognized can be cropped from a larger video sequence, and utilized for action recognition. Similarly, if a customer is identified holding a product, additional cropping of the held product is applied so this cropped image can be utilized for product recognition, and as a training image for the product recognition database.

In specific system configuration a weighing system is incorporated into the AIC. The weight is captured by a specialized weighing module (load-cell 103) located beneath AIC 10 basket 107. The weight module is configured to provide a measure of the weight added to the AIC's basket upon a product insertion or the weight reduced upon product removal. It is assumed that the cart will undergo various accelerations during its travel within the store, producing noisy measurements that may falsely indicate a weight change or provide inaccurate weight measurements. Therefore, the weight signal needs to be processed to obtain an accurate weight estimation and avoid falsified weight measurements. The weight signal is processed by the ‘Weight Processing Module’ 103 to filter the weight signal, establish the correct weight measurement and identify true weight changes that originate from a product insertion/removal. In an exemplary implementation, weight processing module 103 is configured to distinguish between events of product insertion/removal into the cart from false and intermittent weight fluctuations originating from cart's accelerations and/or sudden decelerations. For example, one algorithm in the weight processing module is responsible for locating steady regions within the weight output signals. These regions usually correspond to a motionless cart. An accurate and reliable weight estimation can be provided during such motionless periods. Signal-based statistical measures can also be used to identify immobile cart from a moving cart. Other data analysis methods can be used interchangeably to identify an immobile cart. In addition, ‘Outwards cameras forming a portion of imaging module set’ 105j can be used to identify whether the cart is in motion or not, using for example optical flow of a recognized landmark in the store/warehouse. However, due to expected customer's obstructions and other moving objects, this approach can be less accurate for detection of a stand-still cart.

The location sensor picks up output signals from various transmitting sources located within the store. For example, UWB (ultra-wide band) transmits pulses that are picked by the sensor located on the AIC. Typically, multiple transmitters are positioned in the store. Using multiple UWB transmitters and specialized algorithms it is possible to obtain the cart's position within the store.

When the store Planogram is provided, the position of the cart within the store can help strengthen the verification of an inserted product. Although a customer is free to move without the AIC, it is reasonable that an inserted product is picked in the vicinity of the cart's location. The distance between the cart and the location of the visually proposed products can be used as prior information to improve verification. Moreover, it is possible to fuse information removed from the action recognition module such as captured from the outward-looking cameras forming a portion of imaging module set 105j and decide whether a customer picked a product in the vicinity of the cart or from an unknown location.

The classifier database 250 stores all classifiers needed for the ‘Action Recognition Module’ 220, ‘Product Recognition Module’ 230 and the ‘Image Processing Module’ 210. The ‘Action recognition module’ 220 process input videos (or video clips) for action inference. Action recognition module 220 can communicates with classifier database 250 to retrieve relevant classifiers needed for the action recognition, then process the input signals to provide classification for the actions in the video (or video clips) and their time of occurrence.

Similarly, AIC 10 can utilize multiple CNNs for product recognition, where each CNN can be configured to provide classifications for all products or a portion of the available products in a store/warehouse. The selection of which CNN to use for inference is accomplished for example, by extracting product characteristics and features such as weight, shape, color, textual information, location within the store and product features and selecting a CNN which was trained on products sharing similar characteristics. The relevant models are retrieved on-demand from the classifier database.

As further illustrated in FIG. 2. ‘Data Fusion and Decision Module’ 240, can be configured to analyze input signals from all sensors (load cell module 103, bar code scanner 130, location transceiver 120, e.g.,) and imaging modules 104i, 105j, and 106k, and further process them for purchase marking verification (e.g., on the user interface display). Each product insertion and/or removal is followed by a verification procedure (see e.g., FIGS. 3, and 4). In addition, the entire accumulated purchase may undergo additional verification processing upon termination of the purchasing process. Purchase termination can be identified by the customer notifying the system through its user-interface (for example by requesting to process the purchase payment). Another option can be, for example by moving AIC 10 to a designated checkout area within the store/warehouse. Identification of a cart moving to a designated checkout area is accomplished by the indoor positioning (locator) module 120 or by a designated RFID located on the AIC.

Each verification output is sent to ‘Verification Notification Module’ 260. If a verification failed, notification module 260 can provide notifications for the failed verification to the customer and the store operators. The set of action that are produced upon verification failure can be configured. The verification notification includes information related to the specific event and can comprise, for example; customer identification information, time of occurrence, location in the store, associated barcodes (if scanned), product number, product weight, images and videos related to the verification, and other product related information which can be used to resolve un-verified purchases.

The various AIC verification steps are processed in an exemplary implementation by ‘Data Fusion and Decision Module’ 240. There are multiple verification flows used for customer action verification. These flows are intended to capture various scenarios of misuse and fraudulent behavior. The verification steps descried below are provided for descriptive purposes. Other variants can be used interchangeably without altering the spirit and scope provided herein.

One important verification scenario provided by AIC system 10 is that product scanning had occurred, and was recognized prior to product insertion into basket 107. The detection of product scanning can be made by obtaining a scanned barcode reading from the barcode reader or by some other product registration through UI, and/or by action recognition using the deep machine learning methods provided. It is expected therefore, that a barcode scanning event will be followed simultaneously by a detection of product insertion. Such detection can be accomplished by basket 107 weighing module 103 and/or by visual recognition by horizontal 106k and/or Basket 104i imaging module sets. For verification purposes and as illustrated in FIG. 3A in certain configurations, it is expected that the barcode scanning event 300 will be followed with the product insertion event in within a short duration. If, for example, a longer time has elapsed, the system needs to further verify that the scanned product wasn't replaced by another product, or whether the customer decided to return the product to the shelf. This can be accomplished by visual verification or weight verification or a combination of the these two.

Weight verification is accomplished by matching 305 the weight of the scanned 300 product as provided in weight database 145 (see e.g., FIG. 3A) to the measured weight 304 of an inserted product. For verification purposes, the measured weight 304 is expected to match the database 145 weight within a specified and configurable tolerance. Moreover, visual verification can be accomplished by means of object recognition. Both the Basket 104i and horizontal 106k imaging module sets capture 306 the object during and after its placement within AIC's 10 basket 107. Image cropping algorithms identify the product location within the image captured and provide cropped image-regions to an object-recognition algorithm 308, such as a classifier, that provide 309 predictions 310 for the object in the images. The classifier is configured to provide multiple candidates 310 for the product in the image with associated confidence measures. Current state-of-the-art classifiers for visual object/product recognition in images are based on deep-convolutional-neural-networks (a.k.a. ‘Conv-nets’ or CNN). Convolutional networks are trained on identifying objects/products by providing annotated images showing that specific product. Known examples of CNN's suitable for product recognition can be, for example, at least one of: Inception, Xception, Resnet, Densnet, visual geometry group (VGG) and their variants.

If the scanned product doesn't match in weight 305 and/or is not included 316 in the visual candidate list the system may label this insertion as a failed-verification 312. Failed product insertion verifications can be followed by various notifications to the customer and the store operators. Example of such notifications include
request the user to re-scan 314 the newly inserted product by an audio and or video messaging
Presenting instruction to the user on how to use the AIC
Request the user to present the product wrap to one or more of the imaging modules in the AIC
Notify the store operators that the basket may contain items that were not properly verified.

Another verification mechanism is intended to detect events where a product was inserted to the cart's basket without scanning it first by the barcode-reader. Such scenario can be detected for example, by recording a weight increase without obtaining a new reading from the barcode scanner. Moreover, the system can capture and detect actions of product insertions via ‘Action recognition module’ 220. Additionally, imaging module sets 104i, 105j, and 106k, can also be used to capture and detect product insertions. If such verification failure scenario is detected, the insertion is tagged as a failed-verification purchase and can be accompanied by one of the notification actions specified above.

In an exemplary implementation, the systems provided herein are used to implement the methods described. Accordingly, provided herein is a computerized method of verifying product insertion in a shopping cart of at least one of a store, and a warehouse, implemented in a system for automated product verification, the system comprising: the shopping cart having a front wall, a rear wall and two side walls forming an apically open container with a base; a product recognition module; a user interface module; a load cell module operably coupled to the base of the cart; a plurality of imaging modules coupled to the cart, adapted to capture at least one of image an item inserted into the cart, and image of an area of interest outside the cart; an indoor location sensor; a central processing module in communication with the: user interface module; the load cell and the plurality of imaging modules, the central processing module comprising at least one processor and being in further communication with a non-volatile memory storing: an action recognition module; an items' characteristics database; an items' features database; items' classifiers' database; a data fusion and decision module; a verification and notification module; and a processor readable media comprising a set of executable instruction, configured, when executed to cause the at least one processor to recognize an action by a user associated with at least one of a product insertion, and a product removal from the cart; the method comprising: using the at least one of the imaging modules, identifying an action by the user associated with at least one of insertion, and removal of an item into or out of the shopping cart; determining if the at least one of insertion and removal of the item is recorded by the product recognition module; and if the item is recorded by the product recognition module, and using the verification and notification module, mark the item insertion or removal as verified; else using the verification and notification module, notify at least one of the user, the store, and the warehouse of an unverified insertion and/or removal of the item. In notifying the store and or ware house operators, the system can be configured to generate an alert in the form of at least one of an audio signal, an SMS, an email and the like to a system in communication with the appropriate personnel in the store and/or warehouse.

Furthermore, in the methods implemented using the systems provided the step of determining if the insertion of the item is correctly recorded by the product recognition module further comprises: using the items' characteristics (weight) database 145, determining 303 the expected weight of the inserted item based on the scanned bar-code 300; using the load cell module, obtaining 304 the scanned item's actual weight; and if 305 the scanned item's actual weight is identical to the expected weight retrieved from the product characteristics database then: using at least one of the imaging modules' or the product characteristics database, obtaining 306 an image of the scanned inserted item 301; selecting 308 a classifier for item recognition from 307 the classifier database 250; applying 309 the classifier to the image; generating 310 a list of probable candidate items: and if 311 the scanned item is in the candidate list, marking the insertion as verified 315, else 316 marking the insertion as unverified and notifying 312 at least one of the user, the store and the warehouse; else if the scanned item's actual weight is not identical (within predetermined tolerance) 305 to the expected weight retrieved from the product characteristics database, marking 312 the insertion as unverified and notifying 313, 314 at least one of the user, the store and the warehouse.

Conversely, FIG. 3B, illustrates a flowchart for a similar method using visual verification only for product insertion verification, in other words, without a weight measure, as implemented in an exemplary configuration in a system without load cell of weight system 103. In the first step 350 a video or a set of images, whether a short clip or a series of still images, are processed for action recognition. If an insertion event was detected 351 by action recognition module 220 (see e.g., FIG. 2), the system will check if the insertion was preceded by at least one action of barcode scanning 352, product identification by the product recognition module 230 (see e.g., FIG. 2), or any other product registration mechanism. If insertion occurred 351 prior to such registration of a product in the cart, a notification can be provided to the user and/or the store. For example, upon detection of such event 354, the user is notified 364 for inserting a product prior to its registration in the system, and requested to scan the product 365 and then insert back to the cart. After successful matching between a product-insertion event and a product registration 353, product images are further processed for product recognition for verifying correct product registration. The product verification illustrated in steps 355-358 was specified above. If 359 the inserted product matches 360 in appearance to the registered product, the insertion/purchase is considered as verified 361. This verification process can be accompanied by additional verification stages, such as, counting the number items placed in the basket, detecting events of simultaneous product insertions. If however, a barcode scanning event was not detected 354 by action recognition module 220 (see e.g., FIG. 2), the purchase is marked as unverified, 363, a notification is provided 364 to the user and/or the store client, and an additional request to scan the product 365, is displayed on the UI to the user, for additional scanning inquiry 352 by the system. Likewise, if upon inquiry 359 the inserted product does not match the registered product 361, the insertion/purchase is considered and marked as unverified, 363, a notification is provided 364 to the user and/or the store client, and an additional request to scan the product 365, is displayed on the UI to the user, for additional scanning inquiry 352 by the system.

Another scenario that can occur and addressed by the systems methods and programs provided herein, is where a scanned product is replaced with another product/item prior to its placement in the AIC basket. Such scenario can lead to income loss when the scanned product is cheaper than the product actually placed in the AIC's basket. This scenario is typically harder to detect since both product-scanning and product-insertion took place in the correct order. Detecting such scenario can be done, for example either visual verification of the inserted product, weight verification, or by both weight verification and visual verification. If the weight of the inserted product is different than the weight of the scanned product, the weight system may detect such mismatch. However, in certain conditions the weights difference between the scanned and placed product may be the same or below the predetermined tolerance. In such cases the system imaging' modules 104i, 105j, and 106k are used to check if the placed product matches in visual appearance to the scanned product. The method used for such visual verification is, for example via a deep-convolutional-neural-network (CNN) as described above. Moreover, with horizontal cameras forming a portion of imaging module set 106k it is possible to identify the customer actions (e.g., using for example a skeleton model) prior to the products insertion. If a captured image sequence is provided to the action-recognition algorithm, the output it is expected to identify that product scanning was followed by product replacement prior to a product insertion into the AIC's basket

The visual verification is based on utilizing a single or multiple CNN's. In smaller stores where the number of products' SKUs is limited, a single CNN may be sufficient to achieve the desired accuracy. For large stores, where typically thousands of products' SKUs are available for purchase, a single CNN may not suffice. This loss of recognition accuracy when the number of classes increase is known in literature as the network/model capacity problem. In such conditions the AIC can utilize multiple CNNs where each CNN can provide classifications for a portion of the available products, or alternatively or additionally for certain locations within the store/warehouse. The selection of which CNN to use for inference is accomplished by extracting product characteristics and features such as weight, shape, color, textual information and product features, and selecting a CNN which was trained on products sharing similar characteristics.

The AIC systems, methods and programs allow products to be removed from the cart and automatically verified. For example, as illustrated in FIG. 4A, the product selected for removal 400 may be rescanned by the barcode scanner or manually deleted from a list of purchased products. In such cases it is desired to verify that the product that was physically removed from the cart's basket, is the product that was selected for removal. The verification steps taken to verify correct product removal include computation 404 of the removed weight and matching it to the expected weight reduction based on the ground-truth weight 402 taken 403 from the products weight database 145. Visual recognition 406-410 is used to predict whether 411 the removed product matches in appearance to the scanned/marked product.

Accordingly, and in an exemplary implementation, in the methods implemented using the systems provided, the step of determining if the removal of the item is correctly recorded by the product recognition module further comprises: using the items' characteristics database and feature database, determining the expected 402 weight of the item to be removed based on the rescanned bar-code 401; using the load cell module, obtaining 404 the actual weight of the rescanned 401 item to be removed 400; and if 405 the actual weight of the scanned item to be removed is identical (within predetermined tolerance) to the expected weight retrieved 403 from the product characteristics database then: using at least one of the imaging modules' or the product characteristics database, obtaining 406 an image of the scanned inserted item; selecting 408 at least one classifier for item recognition from 407 the classifier database; applying 409 the classifier to the image; generating 410 a list of probable candidate items: and if 411 the scanned item to be removed is in the candidate list, marking 415 the removal as verified, else 416 marking the removal as unverified 412 and notifying 413, 414 at least one of the user, the store and the warehouse; else if 405 the actual weight of the scanned item to be removed is not identical to the expected weight retrieved from the product characteristics database, marking 412 the removal as unverified and notifying 413, 414 at least one of the user, the store and the warehouse.

Conversely, and similar to the method illustrated by the flow cart of FIG. 3B, FIG. 4B, illustrates a flowchart for a similar method as the exemplary configuration illustrated in FIG. 4A, using visual verification only for product extraction, and/or removal, and/or replacement verification, in other words, without a weight measure, as implemented in an exemplary configuration in a system without load cell of weight system 103. If an item was marked 451 for removal, either through the AIC UI, for example, by deleting it from the list of previously purchased goods, or by some other mechanism, an acquired video or a set of images, whether a short clip or a series of still images, are processed for action recognition. Action recognition 452 is used to verify that an actual product extraction out of the AIC basket took place. If 452 an extraction/removal event was not detected 454 by action recognition module 220 (see e.g., FIG. 2), the removal is marked as unverified 462, and a notification can be provided to the user and/or the store 463. For example, upon detection of such event, the user is notified 465 for not removing a product from the basket with a request 464 to return the correct item to the shelf. After successful matching between a product-extraction event 453 and a matching update of the list of purchased goods, product images are further processed for product recognition for verifying correct product removal 455-458. The product verification was specified above. If the extracted product matches 459 in appearance to the product marked for removal, the extraction is considered as verified and marked 461 accordingly. If however, if upon inquiry 458 the inserted product does not match the registered product 460, the extraction/removal is considered false and marked as unverified, 462, a notification is provided 463 to the user and/or the store client, and an additional request 464 to remove the product sought to be removed 465, is displayed on the UI to the user, for additional action detection inquiry 452 by the system.

The verification steps described herein are computed within the central processing module 150 of the AIC. The various software and hardware component are described in FIG. 2. Furthermore, the verification steps described here are representatives of the multiple achievable exemplary implementation that can be made for verifications, and are provided as examples. There are multiple variants incorporating the plurality of sensor data. This redundancy of sensors, camera views and verification work-flows are utilized to achieve robust product-grade verification system that can successfully operate under challenging conditions. It is clear that there are multiple verification work-flow variants incorporating such sensor data that are not described specifically herein.

Reference in the specification to “one exemplary implementation”, “an exemplary implementation”, “some exemplary implementations” or “other exemplary implementations” means that a particular feature, structure, or characteristic described in connection with the exemplary implementations is included in at least one exemplary implementation, but not necessarily all exemplary implementations, of the inventions. It is understood that the phraseology and terminology employed herein is not to be construed as limiting and are for descriptive purpose only.

As indicated, provided herein is a computer program, comprising program code means for carrying out the steps of the methods described herein, implementable in the systems provided, as well as a computer program product (e.g., a micro-controller) comprising program code means stored on a medium that can be read by a computer, such as a hard disk, CD-ROM, DVD, USB, SSD, memory stick, or a storage medium that can be accessed via a data network, such as the Internet or Intranet, when the computer program product is loaded in the main memory of a computer [or micro-controller] and is carried out by the computer [or micro controller].

Memory device as used in the methods, programs and systems described herein can be any of various types of memory devices or storage devices. The term “memory device” is intended to encompass an installation medium, e.g., a CD-ROM, SSD, or tape device; a computer system memory or random access memory such as DRAM, DDR RAM, SRAM, EDO RAM, Rambus RAM, etc.; or a non-volatile memory such as a magnetic media, e.g., a hard drive, optical storage, or ROM, EPROM, FLASH, SSD, etc. The memory device may comprise other types of memory as well, or combinations thereof. In addition, the memory medium may be located in a first computer in which the programs are executed, and/or may be located in a second different computer [or micro controller] which connects to the first computer over a network, such as the Internet [or, they might be even not connected and information will be transferred using USB]. In the latter instance, the second computer may further provide program instructions to the first computer for execution.

Unless specifically stated otherwise, as apparent from the description, it is appreciated that throughout the specification discussions utilizing terms such as “processing,” “loading,” “in communication,” “detecting,” “calculating,” “determining”, “analyzing,” “obtaining”, “analyzing”, “comparing”, “displaying”, “presenting”, “retrieving” or the like, refer to the action and/or processes of a computer or computing system, or similar electronic computing device, that manipulate and/or transform data represented as physical, such as the captured and acquired image of the product inserted into the cart (or removed) into other data similarly represented as series of numerical values, such as the transformed data.

Furthermore, in relation to systems, methods, programs, AIC, and SSCR, the term “operable” means the system and/or the device and/or the program, or a certain element or step within is/are fully functional sized, adapted configured and calibrated, comprises sub-elements for, and meets applicable operability requirements to perform a recited function when activated, coupled, implemented, effected, realized or when an executable program embodied in a set of computer/processor-readable instructions is executed by at least one processor associated with the system and/or the device.

Although this description addresses verification in an AIC and/or SSCR, the system and methods described here are suitable for purchase verification in other point-of-sales such as a self-service checkout system, warehouse and automated warehouse, where products are collected manually and/or automatically, leading to possible income losses incurred due to human/machine errors.

Accordingly, and in an exemplary implementation, provided herein is a computerized method of verifying product insertion in a shopping cart (or a basket, a trolley, a bag, a bagging area and the like) of a store, and/or a warehouse, implemented in a system for automated product verification, the system comprising: the shopping cart having a front wall, a rear wall and two side walls forming an apically open container with a base; a product recognition module; a user interface module; an optional load cell module operably coupled to the base of the cart; a plurality of non-optional imaging module sets coupled to the cart, operable to capture at least one of an image of an item inserted into the cart, and image of an area of interest outside the cart; a central processing module (interchangeable with CPU), in communication with the: user interface module; the optional load cell and the plurality of imaging module sets, the central processing module comprising at least one processor and being in further communication with a non-volatile memory storage device: an action recognition module; an items' characteristics database; An items' feature database; items' classifiers' database; a data fusion and decision module; a verification and notification module; and a processor readable media comprising a set of executable instruction, configured, when executed to cause the at least one processor to, using the imaging module sets—recognize an action by a user associated with a product insertion, and/or a product removal from the shopping cart (AIC); the method comprising: using at least one of the imaging module sets, identifying (in other words, by capturing at least one image of the customer/user or a portion thereof) an action by the user associated with at least one of insertion, and/or removal of an item into, or out of the shopping cart; using the CPU, determining if the at least one of insertion and/or removal of the item is recorded by the product recognition module; and if the item is recorded by the product recognition module, and using the verification and notification module, mark the item insertion, or removal as verified; otherwise (else) using the verification and notification module, notify the store, and/or the warehouse of an unverified insertion and/or removal of the item, wherein (i) the system further comprises a location sensor in communication with the central processing module, (ii) the product recognition module comprises a bar-code scanner, wherein (iii) the step of identifying an action by the user associated with insertion, and/or removal of an item into (the shopping cart, etc.), or out of the shopping cart comprises: using at least one imaging module set and an action-recognition algorithm, identifying an action of “barcode scanning” from a plurality of image frames of the user over a predetermined period, wherein the action recognition, is carried out using at least one Deep neural network (DNN), (iv) the at least one DNN is preceded by a step of using convolutional neural networks (CNN), extracting a plurality of action-recognition features from each of the plurality of frames (thereby forming a “deep feature”, referring to features of the captured frames, which can include visible features as well as latent or hidden features of a digital image analyzed within the chosen CNN. For example, deep features can include one or more feature vectors generated by one or more layers of the CNN to represent the captured frame or frames. Deep features can include, for example, characteristics of the frame(s) at different levels of abstraction generated at various layers of the selected CNN. Deep features can also contain non-linear characteristics of the captured frame or stream of frames that are uninterpretable to human viewers); and inputting the convoluted action recognition (deep) features to the RNN, wherein (v) the plurality of action-recognition features extracted from each of the at least one frame is based on at least a partial skeleton model of the user as synthesized by the CPU from at least one of the imaging module sets, wherein (vi) the RNN is a long-short-term-memory neural network (LSTM), trained to specifically and selectively identify bar-code scanning by the user, wherein (vii) the action by the user associated with insertion, and/or removal of the item into or out of the shopping cart and which is identified by the system is at least one of: approaching a shelf of the at least one of: the store, and the warehouse; picking the item from the shelf; placing the same or different item on the shelf; approaching the AIC with the same or different item; approaching the AIC without a product; maneuvering the AIC in the at least one of: the store, and the warehouse; causing deliberate damage to the AIC; and removing the AIC from the store or warehouse premises, wherein (viii) the step of determining if the insertion of the item is correctly recorded by the product recognition module implemented in the system disclosed where the load cell is present, further comprises: using the items' characteristics database, determining the expected weight of the inserted item based on the scanned bar-code; using the (now non-optional, present) load cell module, obtaining the scanned item's actual weight; and if the scanned item's actual weight obtained by the corresponding input signal from the load cell, is identical (or within a predetermined acceptable range, for example, between about 95%, and about 105%) to the expected (theoretical) weight retrieved from the product characteristics database then: using at least one of the imaging module sets' or the product characteristics database, or product feature database, obtaining an image of the scanned inserted item; using the CPU, selecting a classifier for item recognition from the classifier database; applying the classifier to the image; generating a list of probable (in other words, likely) candidate items (referring to items that match the classifier): and if the scanned item is (in other words—matches an item) on the candidate list, marking (referring to a computer marking, not a print-out) the insertion as verified, else marking the insertion as unverified and, using the verification and notification module, notifying the user, and/or the store, and/or the warehouse; else if the scanned item's actual weight is not identical (or outside the range as discussed above) to the expected weight retrieved from the product characteristics database, marking the insertion as unverified and, using the verification and notification module; notifying the user, and/or the store, and/or the warehouse (that the action is unverified), or (ix) the step of determining if the insertion of the item is correctly recorded by the product recognition module in a system that does not include the load cell module, in other words using solely visual verification) further comprises: using at least one imaging module in the imaging module set, capturing at least one image of the inserted item; using the CPU based on the captured image, and using the product recognition module and classifier database, selecting at least one classifier for item recognition from the classifier database: using the central processing module CPU, applying the classifier to the at least one captured image (or to the deep feature generated by the DNN corresponding to the at least one captured image); using the CPU, generating a list of probable candidate items; and if the scanned item is on the candidate list, marking the insertion as verified; else marking the insertion as unverified and using the verification and notification module, notifying the user, and/or the store, and/or the warehouse personnel, wherein (x) the step of determining if the removal of the item is correctly recorded by the product recognition module further comprises: using the items' characteristics database, determining the expected weight of the item to be removed based on the scanned bar-code; using the load cell module, obtaining the actual weight of the scanned item to be removed; and if the actual weight of the scanned item to be removed is identical to the expected weight retrieved from the product characteristics database then: using at least one of the imaging modules' or the product characteristics database, obtaining an image of the scanned inserted item; selecting a classifier for item recognition from the classifier database; applying the classifier to the image; generating a list of probable candidate items: and if the scanned item to be removed is in the candidate list, marking the removal as verified, else marking the removal as unverified and notifying at least one of the user, the store and the warehouse; else if the actual weight of the scanned item to be removed is not identical to the expected weight retrieved from the product characteristics database, marking the removal as unverified and notifying at least one of the user, the store and the warehouse, wherein (xi) the method further comprising the step of: synchronizing at least one of: the sampling time, and the sampling rate of an input signal provided by each of the plurality of imaging module sets, the optional load cell, and a location sensor, and wherein (xii) the step of determining if the removal of the item is correctly recorded by the product recognition module in a system that does not include the load cell module, in other words using solely visual verification, further comprises: using the imaging module set, either capturing at least one image of the item sought to be removed; selecting at least one classifier for item recognition from the classifier database: using the CPU, applying the classifier to the at least one captured image (of the item(s) sough to be removed); using the CPU, generating a list of probable candidate items; and if the scanned item is on the candidate list, marking the item's removal as verified; else marking the item's removal as unverified and using the verification and notification module, notifying the user, and/or the store, and/or the warehouse personnel, whether in a message, email or other methods.

In another exemplary implementation, provided herein is a system for automatic verification of insertion and/or removal of an item from an artificially intelligent shopping cart (AIC), the system comprising: the shopping cart having a front wall, a rear wall and two side walls forming an apically open container with a base; a product recognition module; a user interface module; optionally, a load cell module operably coupled to the base of the shopping cart; non-optionally, a plurality of imaging module sets coupled to the cart, operable to capture at least one of: an image of an item inserted into the cart, an image of an item removed from the shopping cart, and an image of an area of interest outside the cart; and a central processing module in communication with the: user interface module; the optional load cell and the plurality of non-optional imaging modules, the central processing module comprising at least one processor and being in further communication with a non-volatile memory storing: an action recognition module; an items' characteristics database; an items' feature database; items' classifiers' database; a data fusion and decision module; a verification and notification module; and a processor readable media comprising a set of executable instruction, configured, when executed, to cause the at least one processor to perform the steps of: identifying an action by a user associated with at least one of: a product insertion, and a product removal from the cart; determine if the at least one of: insertion, and removal of the item is recorded by the product recognition module; and if the item is recorded by the product recognition module, and using the verification and notification module, mark the item insertion, or removal as verified; else using the verification and notification module, notify at least one of: the user, the store, and the warehouse of an unverified insertion and/or removal of the item, further comprising (xiii) a location sensor in communication with central processing module, wherein (xiv) the set of executable instruction, configured, when executed, to cause the at least one processor to perform the step of: synchronizing at least one of: the sampling time, and the sampling rate an input signal provided by each of the plurality of imaging module sets, and/or the location sensor, wherein (xv) the product recognition module comprises a bar-code scanner, wherein (xvi) to identify an action by the user associated with at least one of: insertion, and removal of an item into, or out of the shopping cart, the set of executable instruction is further configured, when executed, to cause the at least one processor to: using at least one imaging module set and an action-recognition algorithm, identify an action of barcode scanning from at least one image frame of the user over a predetermined period, wherein the action recognition, is carried out using Deep neural network (DNN), wherein (xvii) the DNN is preceded by using convolutional neural networks (CNN), extract a plurality of action-recognition features from each of the plurality of frames; and input the convoluted action recognition features to the RNN, (xviii) the plurality of action-recognition features extracted from each of the plurality of frames are based on at least a partial skeleton model of the user, wherein (xix) the RNN is a long-short-term-memory neural network (LSTM), trained to specifically identify bar-code scanning by the user, wherein (xx) the action by the user associated with at least one of insertion, and removal of an item into or out of the shopping cart and which is identified by the system is at least one of: approaching a shelf of the at least one of: the store, and the warehouse; picking the item from the shelf; placing the same or different item on the shelf; approaching the AIC with the same or different item; approaching the AIC without a product; maneuvering the AIC in the at least one of: the store, and the warehouse; deliberately damaging the AIC; and removing the AIC from the premises of the store or warehouse, wherein (xxi) to determining if the insertion of the item is correctly identified and recorded by the product recognition module, the set of executable instruction is further configured, when executed, to cause the at least one processor to: using the items' characteristics database, determine the expected weight of the inserted item based on the scanned bar-code; using the load cell module, obtain the scanned item's actual weight; and if the scanned item's actual weight is identical to the expected weight retrieved from the product characteristics database then: using at least one of the imaging modules' or the product characteristics database, obtain an image of the scanned inserted item; select at least one classifier for item recognition from the classifier database; apply the at least one classifier to the image; generate a list of probable candidate items: and if the scanned item is in the candidate list, mark the insertion as verified, else mark the insertion as unverified and notify at least one of the user, the store and the warehouse; else if the scanned item's actual weight is not identical to the expected weight retrieved from the product characteristics database, mark the insertion as unverified and notify at least one of the user, the store and the warehouse, and (xxii) to determining if the removal of the item is correctly identified and recorded by the product recognition module, the set of executable instruction is further configured, when executed, to cause the at least one processor to: using the items' characteristics database, determine the expected weight of the item to be removed based on the scanned bar-code; using the load cell module, obtain the actual weight of the scanned item to be removed; and if the actual weight of the scanned item to be removed is identical to the expected weight retrieved from the product characteristics database then: using at least one of the imaging modules' or the product characteristics database, obtain an image of the scanned inserted item; select a classifier for item recognition from the classifier database; apply the classifier to the image; generate a list of probable candidate items: and if the scanned item to be removed is in the candidate list, mark the removal as verified, else mark the removal as unverified and notify at least one of the user, the store and the warehouse; else if the actual weight of the scanned item to be removed is not identical to the expected weight retrieved from the product characteristics database, mark the removal as unverified and notifying at least one of the user, the store and the warehouse, or (xxiii) to determining if the insertion of the item is correctly identified and recorded by the product recognition module, the set of executable instruction is further configured, when executed, to cause the at least one processor to: using the imaging module set, capturing at least one image of the inserted item; selecting at least one classifier for item recognition from the classifier database: using the CPU, applying the classifier to the at least one captured image; using the CPU, generating a list of probable candidate items; and if the scanned item is on the candidate list, marking the insertion as verified; else marking the insertion as unverified and notifying at least one of: the user, the store, and the warehouse, and (xxiv) to determining if the removal of the item is correctly identified and recorded by the product recognition module, the set of executable instruction is further configured, when executed, to cause the at least one processor to: using the imaging module set, capturing at least one image of the item sought to be removed; selecting at least one classifier for item recognition from the classifier database: using the CPU, applying the classifier to the at least one captured image; using the CPU, generating a list of probable candidate items; and if the at least one captured image of the item is on the candidate list, marking the removal as verified; else marking the removal as unverified and notifying at least one of: the user, the store, and the warehouse.

In yet another exemplary implementation, provided herein is a computerized method for identifying an action by the a user for validating and verifying correct product insertion and removal from a self-service cash register (SSCR), which is associated with at least one of: insertion, and removal of an item into or out of a bag, the method comprising: using at least one imaging module and an action-recognition algorithm, identifying at least one of: an action of barcode scanning, and presentation of the item to a visual product recognition module, a product insertion, and a product extraction, each obtained from at least one captured image of the user over a predetermined period.

While the invention has been described in detail and with reference to specific exemplary implementations thereof, it will be apparent to one of ordinary skill in the art that various changes and modifications can be made therein without departing from the spirit and scope thereof. Accordingly, it is intended that the present disclosure covers the modifications and variations of this invention provided they come within the scope of the appended claims and their equivalents.

What is claimed:

1. A computerized method of verifying product insertion in a shopping cart of at least one of: a store, and a warehouse, implemented in a system for automated product verification, the system comprising: the shopping cart having a front wall, a rear wall and two side walls forming an apically open container with a base; a product recognition module; a user interface module; an optional load cell module operably coupled to the base of the cart; a plurality of non-optional imaging module sets, coupled to the cart, adapted to capture at least one of an image of an item inserted into the cart, and image of an area of interest outside the cart; a central processing module in communication with the: user interface module; the load cell and the plurality of imaging module sets, the central processing module comprising at least one processor and being in further communication with a non-volatile memory storing:
i. an action recognition module;
ii. an items' characteristics database;
iii. An items' feature database;
iv. items' classifiers' database;
v. a data fusion and decision module;
vi. a verification and notification module; and
vii. a processor readable media comprising a set of executable instruction, configured, when executed to cause the at least one processor to recognize an action by a user associated with at least one of a product insertion, and a product removal from the cart;
the method comprising:
a. using the at least one of the imaging module sets, identifying an action by the user associated with at least one of insertion, and removal of an item into or out of the shopping cart;
b. determining if the at least one of insertion and removal of the item is recorded by the product recognition module; and
c. if the item is recorded by the product recognition module, and using the verification and notification module, mark the item insertion or removal as verified; else
d. using the verification and notification module, notify at least one of the user, the store, and the warehouse of an unverified insertion and/or removal of the item.

2. The method of claim 1, wherein the system further comprises a location sensor in communication with central processing module.

3. The method of claim 1, wherein the product recognition module comprises a bar-code scanner.

4. The method of claim 3, wherein the step of identifying an action by the user associated with at least one of insertion, and removal of an item into or out of the shopping cart comprises: using at least one imaging module set and an action-recognition algorithm, identifying an action of barcode scanning from a plurality of image frames of the user over a predetermined period, wherein the action recognition, is carried out using Deep neural network (DNN)

5. The method of claim 4, wherein the DNN is preceded by
a. using convolutional neural networks (CNN), extracting a plurality of action-recognition features from each of the plurality of frames; and
b. inputting the convoluted action recognition features to the RNN.

6. The method of claim 5, wherein the plurality of action-recognition features extracted from each of the plurality of frames are based on at least a partial skeleton model of the user.

7. The method of claim 6, wherein the RNN is a long-short-term-memory (LSTM) neural network (LSTM), trained to specifically identify bar-code scanning by the user.

8. The method of claim 7, wherein the action by the user associated with at least one of insertion, and removal of an item into or out of the shopping cart and which is identified by the system is at least one of:
a. approaching a shelf of the at least one of: the store, and the warehouse;
b. picking the item from the shelf;
c. placing the same or different item on the shelf;
d. approaching the AIC with the same or different item;
e. approaching the AIC without a product;
f. maneuvering the AIC in the at least one of: the store, and the warehouse;
g. causing deliberate damage to the AIC; and
h. removing the AIC from the store or warehouse premises.

9. The method of claim 8, wherein the step of determining if the insertion of the item is correctly recorded by the product recognition module further comprises:
a. using the items' characteristics database, determining the expected weight of the inserted item based on the scanned bar-code;
b. using the load cell module, obtaining the scanned item's actual weight; and
c. if the scanned item's actual weight is identical to the expected weight retrieved from the product characteristics database then:
i. using at least one of the imaging module sets' or the product characteristics database, or product feature database, obtaining an image of the scanned inserted item;
ii. selecting a classifier for item recognition from the classifier database;
iii. applying the classifier to the image;
iv. generating a list of probable candidate items: and
v. if the scanned item is on the candidate list, marking the insertion as verified, else marking the insertion as unverified and notifying at least one of: the user, the store, and the warehouse; else
d. if the scanned item's actual weight is not identical to the expected weight retrieved from the product characteristics database, marking the insertion as unverified and notifying at least one of: the user, the store, and the warehouse.

10. The method of claim 8, wherein the step of determining if the insertion of the item is correctly recorded by the product recognition module further comprises:
a. using the imaging module set, capturing at least one image of the inserted item;
b. selecting at least one classifier for item recognition from the classifier database:
c. using the CPU, applying the classifier to the at least one captured image;
d. using the CPU, generating a list of probable candidate items; and
e. if the scanned item is on the candidate list, marking the insertion as verified; else
f. marking the insertion as unverified and notifying at least one of: the user, the store, and the warehouse.

11. The method of claim 8, wherein the step of determining if the removal of the item is correctly recorded by the product recognition module further comprises:
a. using the items' characteristics database, determining the expected weight of the item to be removed based on the scanned bar-code;
b. using the load cell module, obtaining the actual weight of the scanned item to be removed; and
c. if the actual weight of the scanned item to be removed is identical to the expected weight retrieved from the product characteristics database then:
i. using at least one of the imaging modules' or the product characteristics database, obtaining an image of the scanned inserted item;
ii. selecting a classifier for item recognition from the classifier database;
iii. applying the classifier to the image;
iv. generating a list of probable candidate items: and
v. if the scanned item to be removed is in the candidate list, marking the removal as verified, else marking the removal as unverified and notifying at least one of the user, the store and the warehouse; else
d. if the actual weight of the scanned item to be removed is not identical to the expected weight retrieved from the product characteristics database, marking the removal as unverified and notifying at least one of the user, the store and the warehouse.

12. The method of claim 1, further comprising the step of: synchronizing at least one of: the sampling time, and the sampling rate of an input signal provided by each of the plurality of imaging module sets, the optional load cell, and a location sensor.

13. The method of claim 8, wherein the step of determining if the removal of the item is correctly recorded by the product recognition module further comprises:
a. using the imaging module set, capturing at least one image of the item sought to be removed;
b. selecting at least one classifier for item recognition from the classifier database:
c. using the CPU, applying the classifier to the at least one captured image;
d. using the CPU, generating a list of probable candidate items; and
e. if the scanned item is on the candidate list, marking the item's removal as verified; else
f. marking the item's removal as unverified and notifying at least one of: the user, the store, and the warehouse.

14. A system for automatic verification of insertion and/or removal of an item from an artificially intelligent shopping cart (AIC), the system comprising:
a. the shopping cart having a front wall, a rear wall and two side walls forming an apically open container with a base;
b. a product recognition module;
c. a user interface module;
d. optionally, a load cell module operably coupled to the base of the shopping cart;
e. non-optionally, a plurality of imaging module sets coupled to the cart, operable to capture at least one of: an image of an item inserted into the cart, an image of an item removed from the shopping cart, and an image of an area of interest outside the cart; and
f. a central processing module in communication with the: user interface module; the optional load cell and the plurality of non-optional imaging modules, the central processing module comprising at least one processor and being in further communication with a non-volatile memory storing:
i. an action recognition module;
ii. an items' characteristics database;
iii. an items' feature database;
iv. items' classifiers' database;
v. a data fusion and decision module;
vi. a verification and notification module; and
vii. a processor readable media comprising a set of executable instruction, configured, when executed, to cause the at least one processor to perform the steps of:
identifying an action by a user associated with at least one of: a product insertion, and a product removal from the cart;
determine if the at least one of: insertion, and removal of the item is recorded by the product recognition module; and
if the item is recorded by the product recognition module, and using the verification and notification module, mark the item insertion, or removal as verified; else
using the verification and notification module, notify at least one of: the user, the store, and the warehouse of an unverified insertion and/or removal of the item.

15. The system of claim 14, further comprising a location sensor in communication with central processing module

16. The system of claim 15, wherein the set of executable instruction, configured, when executed, to cause the at least one processor to perform the step of: synchronizing at least one of: the sampling time, and the sampling rate an input signal provided by each of the plurality of imaging module sets, and/or the location sensor.

17. The system of claim 14, wherein the product recognition module comprises a bar-code scanner.

18. The system of claim 16, wherein to identify an action by the user associated with at least one of: insertion, and removal of an item into, or out of the shopping cart, the set of executable instruction is further configured, when executed, to cause the at least one processor to: using at least one imaging module set and an action-recognition algorithm, identify an action of barcode scanning from at least one image frame of the user over a predetermined period, wherein the action recognition, is carried out using Deep neural network (DNN).

19. The system of claim 17, wherein the DNN is preceded by
a. using convolutional neural networks (CNN), extract a plurality of action-recognition features from each of the plurality of frames; and
b. input the convoluted action recognition features to the RNN.

20. The system of claim 18, wherein the plurality of action-recognition features extracted from each of the plurality of frames are based on at least a partial skeleton model of the user.

21. The system of claim 19, wherein the RNN is a long-short-term-memory neural network (LSTM), trained to specifically identify bar-code scanning by the user.

22. The system of claim 18, wherein the action by the user associated with at least one of insertion, and removal of an item into or out of the shopping cart and which is identified by the system is at least one of:
a. approaching a shelf of the at least one of: the store, and the warehouse;
b. picking the item from the shelf;
c. placing the same or different item on the shelf;
d. approaching the AIC with the same or different item;
e. approaching the AIC without a product;
f. maneuvering the AIC in the at least one of: the store, and the warehouse;
g. deliberately damaging the AIC; and
h. removing the AIC from the premises of the store or warehouse.

23. The system of claim 19, wherein to determining if the insertion of the item is correctly identified and recorded by the product recognition module, the set of executable instruction is further configured, when executed, to cause the at least one processor to:
a. using the items' characteristics database, determine the expected weight of the inserted item based on the scanned bar-code;
b. using the load cell module, obtain the scanned item's actual weight; and
c. if the scanned item's actual weight is identical to the expected weight retrieved from the product characteristics database then:
i. using at least one of the imaging modules' or the product characteristics database, obtain an image of the scanned inserted item;
ii. select at least one classifier for item recognition from the classifier database;
iii. apply the at least one classifier to the image;
iv. generate a list of probable candidate items: and
v. if the scanned item is in the candidate list, mark the insertion as verified, else mark the insertion as unverified and notify at least one of the user, the store and the warehouse; else
d. if the scanned item's actual weight is not identical to the expected weight retrieved from the product characteristics database, mark the insertion as unverified and notify at least one of the user, the store and the warehouse.

24. The system of claim 19, wherein to determining if the removal of the item is correctly identified and recorded by the product recognition module, the set of executable instruction is further configured, when executed, to cause the at least one processor to:
a. using the items' characteristics database, determine the expected weight of the item to be removed based on the scanned bar-code;
b. using the load cell module, obtain the actual weight of the scanned item to be removed; and
c. if the actual weight of the scanned item to be removed is identical to the expected weight retrieved from the product characteristics database then:
i. using at least one of the imaging modules' or the product characteristics database, obtain an image of the scanned inserted item;
ii. select a classifier for item recognition from the classifier database;
iii. apply the classifier to the image;
iv. generate a list of probable candidate items: and
v. if the scanned item to be removed is in the candidate list, mark the removal as verified, else mark the removal as unverified and notify at least one of the user, the store and the warehouse; else
d. if the actual weight of the scanned item to be removed is not identical to the expected weight retrieved from the product characteristics database, mark the removal as unverified and notifying at least one of the user, the store and the warehouse.

25. The system of claim 21, wherein to determining if the insertion of the item is correctly identified and recorded by the product recognition module, the set of executable instruction is further configured, when executed, to cause the at least one processor to:
a. using the imaging module set, capturing at least one image of the inserted item;
b. selecting at least one classifier for item recognition from the classifier database:
c. using the CPU, applying the classifier to the at least one captured image;
d. using the CPU, generating a list of probable candidate items; and
e. if the scanned item is on the candidate list, marking the insertion as verified; else
f. marking the insertion as unverified and notifying at least one of: the user, the store, and the warehouse.

26. The system of claim 21, wherein to determining if the removal of the item is correctly identified and recorded by the product recognition module, the set of executable instruction is further configured, when executed, to cause the at least one processor to:
a. using the imaging module set, capturing at least one image of the item sought to be removed;
b. selecting at least one classifier for item recognition from the classifier database:
c. using the CPU, applying the classifier to the at least one captured image;
d. using the CPU, generating a list of probable candidate items; and
e. if the at least one captured image of the item is on the candidate list, marking the removal as verified; else
f. marking the removal as unverified and notifying at least one of: the user, the store, and the warehouse

27. A computerized method for identifying an action by the a user for validating and verifying correct product insertion and removal from a self-service cash register (SSCR), which is associated with at least one of: insertion, and removal of an item into or out of a bag, the method comprising: using at least one imaging module and an action-recognition algorithm, identifying at least one of:
a. an action of barcode scanning, and presentation of the item to a visual product recognition module,
b. a product insertion, and
c. a product extraction,
each obtained from at least one captured image of the user over a predetermined period.
